(19) United States
(12) Patent Application Publication
(10) Pub. No.: US 2026/0055827 A1
(43) Pub. Date: Feb. 26, 2026

(54) BALLAST WEIGHT LOCK

(71) Applicant: Longitude 123, Inc., Ventura, CA (US)

(72) Inventor: Mark Steffy, Ojai, CA (US)

(21) Appl. No.: 18/749,397

(22) Filed: Jun. 20, 2024

(51) Int. Cl. F16L 1/24

(52) U.S. Cl. CPC F16L 1/24

(57) ABSTRACT

A pipeline includes a pipe and a ballast weight coupled around the pipe. The pipe includes an anchor ring extending from an exterior surface of the pipe. The ballast weight includes an anchor keyway designed as a channel into an interior surface of the ballast weight, where the anchor ring extends into the anchor keyway.

### TECHNICAL FIELD

This disclosure relates generally to ballast weight devices and processes. More specifically, this disclosure relates to a ballast weight lock.

### BACKGROUND

A combination of air and water, especially salt water, can expose metal pipelines to corrosion. Polyethylene (PE) piping does not suffer to galvanic corrosion, which gives PE piping an advantage over metal pipelines. However, PE piping is much lighter and buoyant than metal piping requiring ballast weight to maintain the weight within the water.

### SUMMARY

This disclosure provides a ballast weight lock.

In a first embodiment, a pipeline includes a pipe and a ballast weight coupled around the pipe. The pipe includes an anchor ring extending from an exterior surface of the pipe. The ballast weight includes an anchor keyway designed as a channel into an interior surface of the ballast weight, where the anchor ring extends into the anchor keyway.

In a second embodiment, a ballast weight assembly includes a thrust anchor and a ballast weight coupled around the thrust anchor. The thrust anchor includes an anchor ring protruding from an exterior surface of the thrust anchor. The ballast weight includes an anchor keyway designed as a channel into an interior surface of the ballast weight, where the anchor ring extends into the anchor keyway.

In a third embodiment, a system includes ballast weight includes an anchor keyway designed as a channel into an interior surface of the ballast weight, where the keyway is configured to receive an anchor ring extending a thrust anchor or a pipe.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example pipeline in accordance with this disclosure;

FIGS. 2A through 2D illustrate an example pipeline with locking bullet ballast in accordance with this disclosure;

FIGS. 3A through 3D illustrate an example pipeline with locking foundation ballast in accordance with this disclosure;

FIGS. 4 and 5 illustrate example ballast weight assemblies in accordance with this disclosure; and

FIGS. 6 and 7 illustrate example thrust anchor keys in accordance with this disclosure.

### DETAILED DESCRIPTION

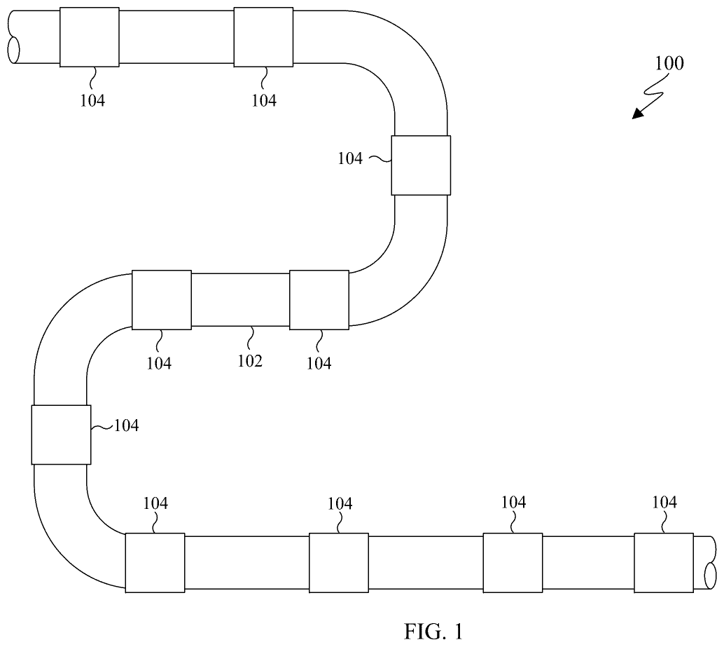

FIGS. 1 through 3D, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

High-Density Polyethylene (HDPE) piping is used in underwater (submarine) pipeline applications to transport fluids under low pressure. The most common use of HDPE pipe in a submarine application is for industrial or sanitation outfalls to transport and discharge effluent and for the transport of freshwater or seawater. They may also be used as intakes to feed or transport fluids. HDPE submarine pipeline applications are typically found in oceans, seas, lakes, rivers, bays, reservoirs, and the like, and while generally horizontal, may also be vertical (deepwater intakes). Horizontal applications typically lay or rest on the seafloor or bed of the water body. Vertical applications may be suspended in the water column from barges, ships, and other floating craft as intakes or discharges serving industrial or other purposes. All HDPE submarine pipeline installations, horizontal or vertical, will float on the surface of the water unless they are ballasted with ballast of some type to make the pipeline negatively buoyant. Alternatively, mechanical anchors may anchor HDPE pipelines to the seafloor or bed. This patent focuses on reinforced concrete ballast to make horizontal HDPE submarine pipelines negatively buoyant. HDPE ballasting typically consists of reinforced concrete half-shells that are designed to be mounted on the girth of the pipeline, and the two halves are fastened together with mechanical fasteners and rely on the compression of the two reinforced concrete ballast halves to lock the ballast onto the pipeline. While common, this method is problematic because the ballast weights are typically installed on the pipeline when it is out of the water. HDPE pipe expands and contracts significantly with the surrounding temperature. Onshore and in the open, the HDPE pipe will expand with the warmth of direct sunlight and air temperatures. In the water, the HDPE will contract when the water temperature is lower than the air temperature. HDPE submarine pipeline construction typically involves fabricating the pipeline onshore, installing a pre-calculated level of ballast at pre-calculated intervals on the pipeline, and then pulling the pipeline offshore and into position of the seafloor or bed. As the pipeline with attached ballast is pulled into the water the half-shell ballast weights lose their compression grip on the exterior girth of the pipeline as the HDPE pipe cools and contracts, and the weights can rotate on the pipeline or slide linear on the pipeline. The linear movement of the ballast weight on the pipeline is particularly undesirable as segments of the pipe may be inadequately ballasted and float to the surface, thereby damaging the pipe.

Ballast weights are designed to be spaced apart along a pipe. If the ballast weight can move linearly along the pipe, then the spacing could be errantly adjusted causing a section of the pipe to not be properly weighted. This improper weighting of the pipe can cause damage to the pipe. Attaching the ballast directly to the pipe can also cause problems. Any rotation of the ballast weight would create torsional stresses that the pipe was not designed to handle. Therefore, a need to limit linear movement along a pipe while not causing significant torsion exists.

FIG. 1 illustrates an example pipeline 100 in accordance with this disclosure. The embodiment of the pipeline 100 illustrated in FIG. 1 is for illustration only. FIG. 1 does not limit the scope of this disclosure to any particular implementation of a pipeline.

As shown in FIG. 1, pipeline 100 can be used to transport fluids through bodies of water for large distances. The pipeline 100 can include pipe 102 and ballast weights 104. The pipeline 100 can be ballasted to the bed of the body of water.

The pipe 102 can continuously extend from a source of a fluid to a recipient of the fluid. The pipe 102 can be made of many pieces coupled together. The pipe 102 can be made of a material designed for use in salt water, such as a high-density polyethylene (HDPE).

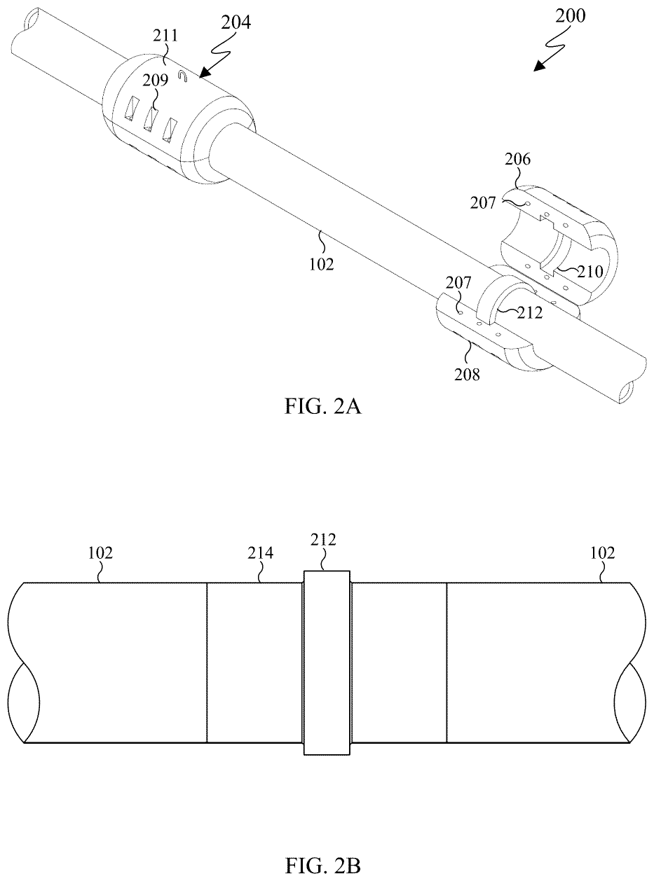

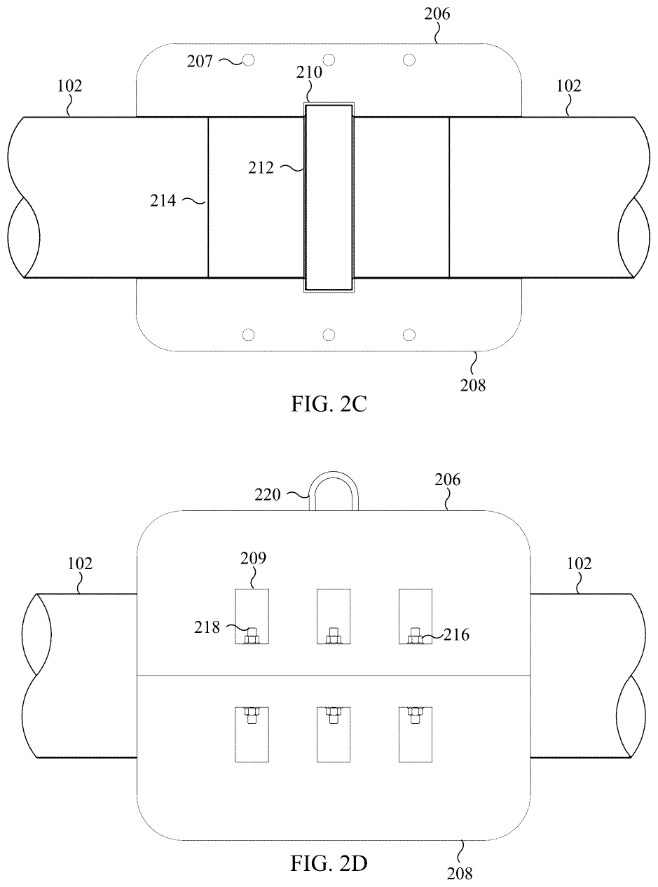

Pipeline using HDPE can provide many benefits to longevity but is much lighter than other materials such as concrete and metal. Using HDPE can reduce equipment required for installation of the pipe 102. HDPE is also less dense than both fresh water and sea water, which means that a pipe 102 made of HDPE floats. Because the pipe 100 float, ballast weights 104 can be used to ballast the pipeline to the bed of a body of water. The pipeline 100 can be designed for a specific amount and arrangement of ballast weights 104. The ballast weights 104 can be bullet ballast weight 204 shown in FIGS. 2A-2D, and weights meant for resting on a floor of a body of water, such as foundation ballast weights 304 shown in FIGS. 3A-3D.

A weight of the ballast weight 104 can be determined based on a weight of the pipeline and the contents it holds minus a weight of water that the pipe 102 displaces. The spacing between ballast weights is subject to distributed loading by a combined effect of current, lift, and waves. The design of the ballast weights 104 in the pipeline 100 can limit resultant pipe deflection to maintain bending stresses and strains within safety thresholds.

The ballast weight 104 can be made of any suitable material that is heavier than water. However, materials such as reinforced concrete is typically used. The ballast weights 104 can be made to different shapes. In certain embodiments, the ballast weights 104 can have a flat bottom.

The ballast weight 104 can be manufactured in two parts. The ballast weight 104 can be manufactured with an inner diameter that is slightly larger than an outer diameter of the pipe 102. The space can be used to adjust the ballast weight 104 along the pipe 102 for repositioning and rotating separately from the pipe 102. The space also decreases friction from movement in the ocean and any expansion of the pipe 102 greater than the ballast weight 104. In certain embodiments, a lining material can be used to reduce friction between the pipe 102 and the ballast weight 104.

Although FIG. 1 illustrates an example pipeline 100, various changes may be made to FIG. 1. For example, the number and placement of various components of the pipeline 100 can vary as needed or desired. In addition, the pipeline 100 may be used in any other suitable fluid transfer process and is not limited to the specific processes described above.

FIGS. 2A through 2D illustrate an example pipeline 200 with a locking bullet ballast weights 204 in accordance with this disclosure. In particular, FIG. 2A illustrates an example pipeline 200, FIG. 2B illustrates an example thrust anchor 214 in the pipeline 200, FIG. 2C a cross-sectional view of an example bullet ballast weights 204 locked onto the thrust anchor 214, and FIG. 2D illustrates an exterior view of an example bullet ballast weights 204 locked onto the thrust anchor. The embodiments of the example pipeline illustrated in FIGS. 2A through 2D are for illustration only. FIGS. 2A through 2D do not limit the scope of this disclosure to any particular implementation of a pipeline.

As shown in FIG. 2A, pipeline 200 can be used to transport fluids through bodies of water for large distances. The pipeline 200 can include pipe 102 and locking bullet ballast weights 204. The pipeline 200 can be secured to a floor of the body of water by the weight of the ballast.

The pipe 102 can continuously extend from a source of a fluid to a recipient of the fluid. The pipe 102 can be made of many pieces coupled together. The pipe 102 can be made of a material designed for use in salt water, such as polyethylene. In certain embodiments, pipe 102 can be made of a high-density polyethylene (HDPE). The pipeline 200 can have pipes 102 that fork, widen, narrow, etc.

The pipe 102 can include a thrust anchor ring 212. The thrust anchor ring protrudes from an exterior surface of the pipe 102. The exterior surface of the pipe 102 is a surface that is exposed to a body of water in which the pipeline 200 is located in. The thrust anchor ring 212 can extend an entire circumference of a cross section of the pipe 102. The cross section of the pipe for the thrust anchor ring 212 is defined based on a cross section perpendicular to a central axis of the pipe 102. The thrust anchor ring 212 can extends in a range from a fraction of an inch to a fraction of an inch less than a thickness of a locking bullet ballast weight 204.

The thrust anchor ring 212 can have any shape for the external surface. For example, the exterior surface of the thrust anchor ring 212 can have a triangle shape, a rounded shape, an inverse “T” shape, etc. The shape of the exterior surface of the thrust anchor ring 212 is designed to match an inner surface of the ballast weight 204 to fix the ballast weight in a position along a direction of the flow path or center of the tube. The exterior shape is also designed to allow the ballast weight 204 to rotate independently from the pipe 102.

In certain examples, more than one thrust anchor ring 212 can be used for a single ballast weight 204. Two or more thrust anchor rings 212 could be used to attach directly ends of adjacent pipes when a thrust anchor 214 is not used.

The thrust anchor ring 212 can be fixed by any means to the pipe 102, including prefabricating the thrust anchor ring 212 on a thrust anchor 214 as shown in FIG. 2B. The thrust anchor 214 can be sized similarly to the pipe 102 in the pipeline 200. That is, the thrust anchor 214 can have a same inner diameter, outer diameter, thickness, etc. The thrust anchor 214 can also be made of PE pipe.

The pipeline 200 can be designed for an amount and arrangement of locking bullet ballast weights 204. The locking bullet ballast weights 204 can be made of concrete or any other suitable material for weighting the PE pipe and resisting corrosion.

The locking bullet ballast weights 204 can include a top bullet ballast weight 206 and a bottom bullet ballast weight 208. The top bullet ballast weight 206 and the bottom bullet ballast weight 208 can be coupled around the pipe 102. The top bullet ballast weight 206 forms approximately half of a locking bullet ballast weight 204 and the bottom bullet ballast weight 208 forms approximately half of the locking bullet ballast weight 204. However, a locking bullet ballast weight 204 can be formed by any number of partial bullet ballast weights 204.

Each of the top bullet ballast weight 206 and the bottom bullet ballast weight 208 can include a thrust anchor keyway 210. The thrust anchor keyway 210 is an indention or cutout around an interior surface of the respective top bullet ballast weight 206 and the bottom bullet ballast weight 208. The interior surface is defined based on a surface that contacts the pipe 102 when the top bullet ballast weight 206 and the bottom bullet ballast weight 208 are coupled together. When top bullet ballast weight 206 and the bottom bullet ballast weight 208 are coupled together, the thrust anchor keyway 210 extends along an inner circumference of the locking bullet ballast weight 204.

The top bullet ballast weight 206 and the bottom bullet ballast weight 208 can include a series of fastening vias 207. The fastening vias 207 can be formed with the respective top bullet ballast weight 206 and the bottom bullet ballast weight 208 or added during assembly of the bullet ballast weight 204. The fastening vias 207 on the top bullet ballast weight 206 can align with the fastening vias 207 on the bottom bullet ballast weight 208. The amount and sizes of fastening vias 207 can vary depending on the forces that the bullet ballast weight 204 is designed to incur when placed under the water. The amount and size of the fastening vias 207 can be different for the top bullet ballast weight 206 and the bottom bullet ballast weight 208.

The top bullet ballast weight 206 and the bottom bullet ballast weight 208 can also include a fastening groove 209 corresponding to each fastening via 207. The fastening groove 209 can allow for fastening equipment to have a surface perpendicular to a centerline of the fastening via 207. The fastening groove 209 can have a depth and width to allow for fastening equipment to accessed and secured to the perpendicular surface. The fastening grooves 209 can be dimensioned in a manner that any fastening equipment is within a profile of the exterior surface 211 of the bullet ballast weight 204.

As shown in FIG. 2C, the thrust anchor keyway 210 and the thrust anchor ring 212 are complimentary shapes. When the locking bullet ballast weight 204 is positioned around the pipe 102 or thrust anchor 214, the thrust anchor ring 212 extends into the thrust anchor keyway 210. Once the thrust anchor ring 212 is inserted into the thrust anchor keyway 210, the locking bullet ballast weight 204 is positioned along the pipeline 200 and does not move linearly along the axis of the pipe 102. However, a small gap between the thrust anchor ring 212 and the thrust anchor keyway allows the pipe 102 and the locking bullet ballast weight 204 to rotate independently. This independent rotation can remove any torque forces between the pipe 102 and the locking bullet ballast weight 204. The locking bullet ballast weight 204 and the thrust anchor 214 can be collectively referred to as a ballast weight assembly.

A width of thrust anchor keyway 210 at an inner surface of the ballast weight 204 is wider than a maximum width of the thrust anchor ring 212. A depth of the thrust anchor keyway 210 is greater than a thickness of the thrust anchor ring 212. A length of the thrust anchor 214 in a direction of a center line of the thrust anchor and the pipe can be less than a length of the ballast weight 204. The thickness of the thrust anchor ring 212 is greater than any gap between the ballast weight 204 and the thrust anchor 214 or the pipe 102.

As shown in FIG. 2D, the locking bullet ballast weight 204 can be coupled together using a series of studs 218 and fasteners 216. Multiple studs 218 can extend through the fastening vias 207 in top bullet ballast weight 206 and the bottom bullet ballast weight 208. Fasteners 216 can be applied at both ends of each stud 218 to secure the top bullet ballast weight 206 to the bottom bullet ballast weight 208.

In certain embodiments, studs 218 can be integrally formed in one of the top bullet ballast weight 206 or the bottom bullet ballast weight 208 to extend through the other of the top bullet ballast weight 206 or the bottom bullet ballast weight 208. A single fastener 216 could be used at an end of the studs 218 extending through the other of the top bullet ballast weight 206 or the bottom bullet ballast weight 208.

The fasteners 216 could be nuts that are threaded to match the ends of the studs extending through either the top bullet ballast weigh 206 or the bottom bullet ballast weight 208. In certain embodiments, the fasteners 216 can be welded, crimped, riveted or any other suitable method for fastening the top bullet ballast weight 206 to the bottom bullet ballast weight 208.

In embodiments where the top bullet ballast weight 206 and the bottom bullet ballast weight 208 are to be similarly formed for simplicity of the assembly, the fastening vias 207 and studs 218 can be arranged in a manner that the top bullet ballast weight 206 can be rotated 180 degrees from an orientation of the bottom bullet ballast weight 208.

The bullet ballast weight 204 can also include a coupler 220 mounted on the exterior surface 211 of the bullet ballast weight 204. The coupler 220 can be formed of a material suitable for under water conditions, such as a stainless steel. The coupler 220 can be mounted on the top bullet ballast weight 206 or the bottom ballast weight 208. In certain embodiments, the coupler 20 is mounted on both of the top bullet ballast weight 206 or the bottom bullet ballast weight 208.

Although FIGS. 2A through 2D illustrate a pipeline 200 with a locking bullet ballast weights 204, various changes may be made to FIGS. 2A through 2D. For example, the number and placement of various components of the pipeline 200 can vary as needed or desired. In addition, the pipeline 200 may be used in any other suitable piping process and is not limited to the specific processes described above.

FIGS. 3A through 3D illustrate an example pipeline 300 with a locking foundation ballast weight 304 in accordance with this disclosure. In particular, FIG. 3A illustrates an example pipeline 300, FIG. 3B illustrates an example thrust anchor 214 in the pipeline 300, FIG. 3C a cross-sectional view of an example foundation ballast weight 304 locked onto the thrust anchor 214, and FIG. 3D illustrates an exterior view of an example foundation ballast weight 304 locked onto the thrust anchor. The embodiments of the example pipeline illustrated in FIGS. 3A through 3D are for illustration only. FIGS. 3A through 3D do not limit the scope of this disclosure to any particular implementation of a pipeline.

As shown in FIG. 3A, pipeline 300 can be used to transport fluids or contain solid, such as data cables, through bodies of water for large distances. The pipeline 300 can include pipe 102 and locking foundation ballast weights 304. The pipeline 300 can float at a specified depth of water or be secured to a floor of the body of water. For example, a specified depth could include a distance from a floor of the body of water, a distance from a surface of the water, etc.

The pipe 102 can continuously extend from a source of a fluid to a recipient of the fluid. The pipe 102 can be made of many pieces coupled together. The pipe 102 can be made of a material designed for use in salt water, such as polyethylene. In certain embodiments, pipe 102 can be made of a high-density polyethylene (HDPE).

The pipe 102 can include a thrust anchor ring 212. The thrust anchor ring 212 protrudes from an exterior surface of the pipe 102. The exterior surface of the pipe 102 is a surface that is exposed to a body of water in which the pipeline 300 is located in. The thrust anchor ring 212 can extend an entire circumference of a cross section of the pipe 102. The cross section of the pipe for the thrust anchor ring 212 is defined based on a cross section perpendicular to a central axis of the pipe 102. The thrust anchor ring 212 can extends in a range from a fraction of an inch to a fraction of an inch less than a thickness of a locking foundation ballast weight 304.

The thrust anchor ring 212 can be fixed by any means to the pipe 102, including prefabricating the thrust anchor ring 212 on a thrust anchor 214 as shown in FIG. 3B. The thrust anchor 214 can be sized similarly to the pipe 102 in the pipeline 300. That is, the thrust anchor 214 can have a same inner diameter, outer diameter, thickness, etc. The thrust anchor 214 can also be made of PE pipe.

The locking foundation ballast weights 304 can include a top foundation ballast weight 306 and a bottom foundation ballast weight 308. The top foundation ballast weight 306 and the bottom foundation ballast weight 308 can be coupled around the pipe 102. The top foundation ballast weight 306 forms approximately half of a locking foundation ballast weight 304 and the bottom foundation ballast weight 308 forms approximately half of the locking foundation ballast weight 304. However, a locking foundation ballast weight 304 can be formed by any number of partial foundation ballast weights.

Each of the top foundation ballast weight 306 and the bottom foundation ballast weight 308 can include a thrust anchor keyway 310. The thrust anchor keyway 310 is an indention or cutout into a channel around an interior surface of the respective top foundation ballast weight 306 and the bottom foundation ballast weight 308. The interior surface is defined based on a surface that contacts the pipe 102 when the top foundation ballast weight 306 and the bottom foundation ballast weight 308 are coupled together. When top foundation ballast weight 306 and the bottom foundation ballast weight 308 are coupled together, the thrust anchor keyway 310 extends along an inner circumference of the locking foundation ballast weight 304. The bottom foundation ballast weight 308 can have a flat surface meant for resting on a bottom surface of a body of water.

As shown in FIG. 3C, the thrust anchor keyway 310 and the thrust anchor ring 212 are complimentary shapes. When the locking foundation ballast weight 304 is positioned around the pipe 102 or thrust anchor 214, the thrust anchor ring 212 extends into the thrust anchor keyway 310. Once the thrust anchor ring 212 is inserted into the thrust anchor keyway 310, the locking foundation ballast weight 304 is positioned along the pipeline 300 and does not move linearly along the axis of the pipe 102. However, a small gap between the thrust anchor ring 212 and the thrust anchor keyway allows the pipe 102 and the locking foundation ballast weight 304 to rotate independently. This independent rotation can remove any torque forces between the pipe 102 and the locking foundation ballast weight 304. The locking foundation ballast weight 304 and the thrust anchor 214 can be collectively referred to as a ballast weight assembly.

As shown in FIG. 3D, the locking foundation ballast weight 304 can be coupled together using a series of stud 218 and fasteners 216. Multiple studs 218 can extend from the bottom foundation ballast weight 308 through the top foundation ballast weight 306. Fasteners 216 are applied at both ends of each stud 218 to secure the top foundation ballast weight 306 to the bottom foundation ballast weight 308.

Although FIGS. 3A through 3D illustrate a pipeline 300 with a locking foundation ballast weight 304, various changes may be made to FIGS. 3A through 3D. For example, the number and placement of various components of the pipeline 300 can vary as needed or desired. In addition, the pipeline 300 may be used in any other suitable piping process and is not limited to the specific processes described above.

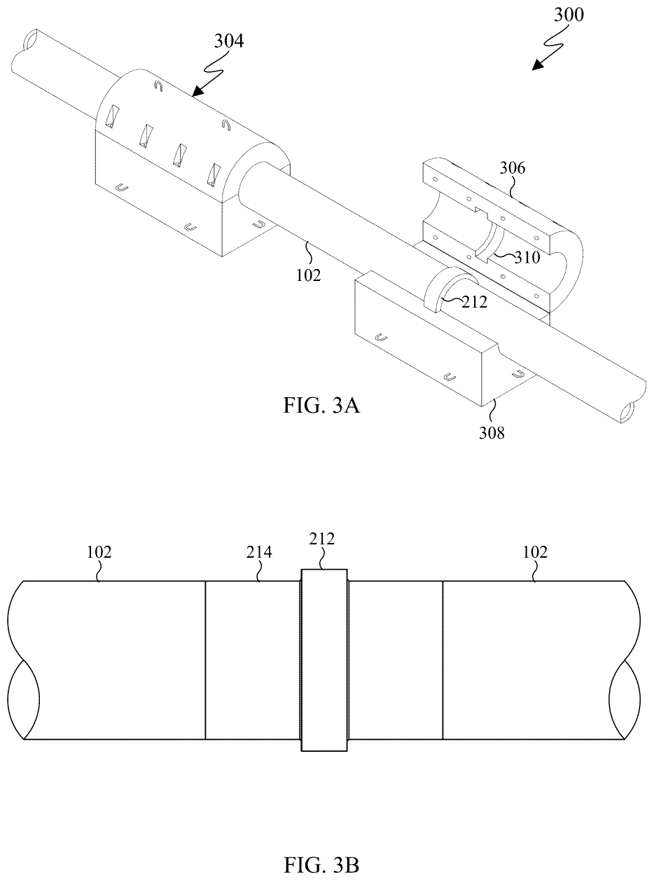

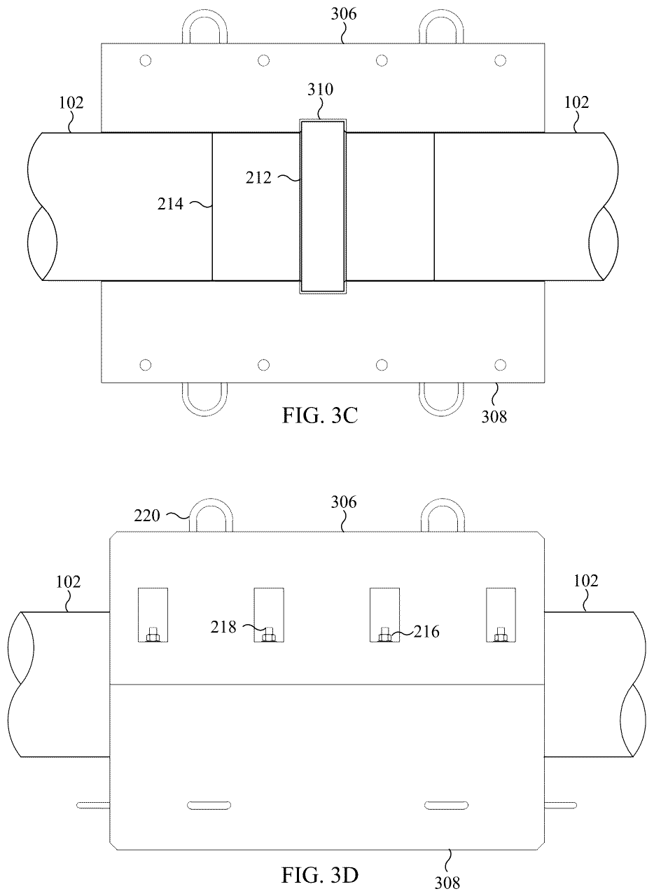

FIGS. 4 and 5 illustrate example ballast weight assemblies 400, 500 in accordance with this disclosure. In particular, FIG. 4 illustrates an example ballast weight assembly 400, and FIG. 5 illustrates an example ballast weight assembly 500. The embodiments of the example ballast weight assemblies 400, 500 illustrated in FIGS. 4 and 5 are for illustration only. FIGS. 4 and 5 do not limit the scope of this disclosure to any particular implementation of a pipeline.

As shown in FIG. 4, thrust anchor ring 412 protrudes from an exterior surface of the thrust anchor 414. The exterior surface of the thrust anchor 414 is a surface that is contacts interior surfaces of the top ballast weight 406 and the bottom ballast weight 408. The thrust anchor ring 412 can extend an entire circumference of a cross section of the thrust anchor 414. The cross section of the pipe for the thrust anchor ring 412 is defined based on a cross section perpendicular to a central axis of the thrust anchor 414. The thrust anchor ring 412 can extends in a range from a fraction of an inch to a fraction of an inch less than a thickness of a locking ballast weight.

The thrust anchor ring 412 can be fixed by any means to the thrust anchor 414, including prefabricating the thrust anchor ring 412 on a thrust anchor 214 as shown in FIG. 3B. The thrust anchor 214 can be sized similarly to the thrust anchor 414 in the pipeline. That is, the thrust anchor 214 can have a same inner diameter, outer diameter, thickness, etc. The thrust anchor 214 can also be made of PE pipe.

Ballast weights can include a top ballast weight 406 and a bottom ballast weight 408. The top ballast weight 406 and the bottom ballast weight 408 can be coupled around a thrust anchor 414. The top ballast weight 406 forms approximately half of a locking ballast weight 404 and the bottom ballast weight 408 forms approximately half of the locking ballast weight 404. However, a locking ballast weight 404 can be formed by any number of partial ballast weights.

Each of the top ballast weight 406 and the bottom ballast weight 408 can include a thrust anchor keyway 410. The thrust anchor keyway 410 is an indention or cutout around an interior surface of the respective top ballast weight 406 and the bottom ballast weight 408. The interior surface is defined based on a surface that contacts the thrust anchor 414 when the top ballast weight 406 and the bottom ballast weight 408 are coupled together. When top ballast weight 406 and the bottom ballast weight 408 are coupled together, the thrust anchor keyway 410 extends along an inner circumference of the locking ballast weight 404.

The thrust anchor keyway 410 and the thrust anchor ring 412 are complimentary shapes. In the illustrated embodiment of FIG. 4, the complimentary shape of a cross section of the thrust anchor keyway 410 and the thrust anchor ring 412 is a semicircle. When the locking ballast weight 404 is positioned around the thrust anchor 414, the thrust anchor ring 212 extends into the thrust anchor keyway 410. Once the thrust anchor ring 412 is inserted into the thrust anchor keyway 410, the locking ballast weight 404 is positioned along the thrust anchor 414 and does not move linearly along the axis of the thrust anchor 414. However, a small gap between the thrust anchor ring 412 and the thrust anchor keyway allows the thrust anchor 414 and the locking ballast weight 404 to rotate independently. This independent rotation can remove any torque forces between the thrust anchor 414 and the locking ballast weight 404.

As shown in FIG. 5, thrust anchor ring 512 protrudes from an exterior surface of the thrust anchor 514. The exterior surface of the thrust anchor 514 is a surface that is contacts interior surfaces of the top ballast weight 506 and the bottom ballast weight 508. The thrust anchor ring 512 can extend an entire circumference of a cross section of the thrust anchor 514. The cross section of the pipe for the thrust anchor ring 512 is defined based on a cross section perpendicular to a central axis of the thrust anchor 514. The thrust anchor ring 512 can extends in a range from a fraction of an inch to a fraction of an inch less than a thickness of a locking ballast weight.

The thrust anchor ring 512 can be fixed by any means to the thrust anchor 514, including prefabricating the thrust anchor ring 512 on a thrust anchor 214 as shown in FIG. 3B. The thrust anchor 214 can be sized similarly to the thrust anchor 514 in the pipeline. That is, the thrust anchor 214 can have a same inner diameter, outer diameter, thickness, etc. The thrust anchor 214 can also be made of PE pipe.

Ballast weights can include a top ballast weight 506 and a bottom ballast weight 508. The top ballast weight 506 and the bottom ballast weight 508 can be coupled around a thrust anchor 514. The top ballast weight 506 forms approximately half of a locking ballast weight 504 and the bottom ballast weight 508 forms approximately half of the locking ballast weight 504. However, a locking ballast weight 504 can be formed by any number of partial ballast weights.

Each of the top ballast weight 506 and the bottom ballast weight 508 can include a thrust anchor keyway 510. The thrust anchor keyway 510 is an indention or cutout around an interior surface of the respective top ballast weight 506 and the bottom ballast weight 508. The interior surface is defined based on a surface that contacts the thrust anchor 514 when the top ballast weight 506 and the bottom ballast weight 508 are coupled together. When top ballast weight 506 and the bottom ballast weight 508 are coupled together, the thrust anchor keyway 510 extends along an inner circumference of the locking ballast weight 504.

The thrust anchor keyway 510 and the thrust anchor ring 512 are complimentary shapes. In the illustrated embodiment of FIG. 5, the complimentary shape of a cross section of the thrust anchor keyway 510 and the thrust anchor ring 512 is triangular or pyramidal. When the locking ballast weight 504 is positioned around the thrust anchor 514, the thrust anchor ring 212 extends into the thrust anchor keyway 510. Once the thrust anchor ring 512 is inserted into the thrust anchor keyway 510, the locking ballast weight 504 is positioned along the thrust anchor 500 and does not move linearly along the axis of the thrust anchor 514. However, a small gap between the thrust anchor ring 512 and the thrust anchor keyway allows the thrust anchor 514 and the locking ballast weight 504 to rotate independently. This independent rotation can remove any torque forces between the thrust anchor 514 and the locking ballast weight 504.

Although FIGS. 4 and 5 illustrate example ballast weight assemblies 400, 500, various changes may be made to FIGS. 4 and 5. For example, the number and placement of various components of the ballast weight assemblies 400, 500 can vary as needed or desired. In addition, the ballast weight assemblies 400, 500 may be used in any other suitable piping process and is not limited to the specific processes described above.

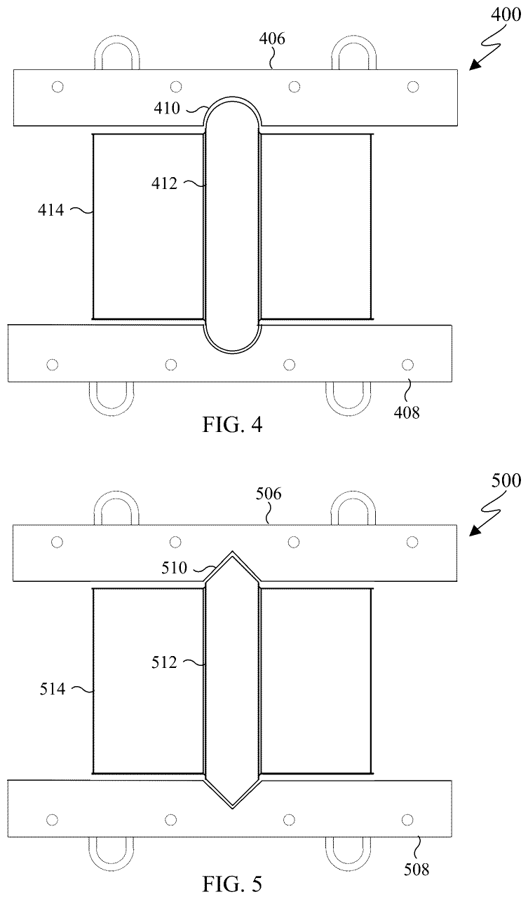

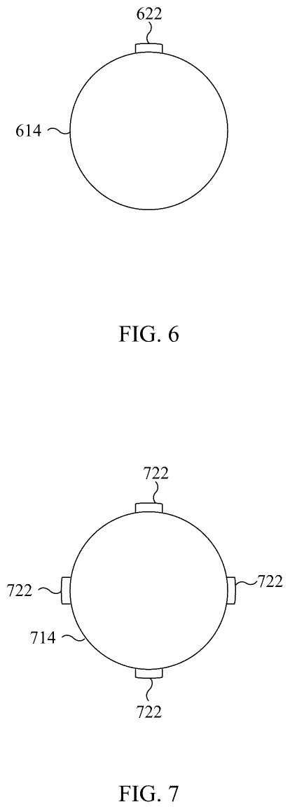

FIGS. 6 and 7 illustrate example thrust anchor keys 622, 722 in accordance with this disclosure. In particular, FIG. 6 illustrates an example thrust anchor key 622, and FIG. 7 illustrates example thrust anchor keys 722. The embodiments of the example anchor keys 622, 722 illustrated in FIGS. 6 and 7 are for illustration only. FIGS. 6 and 7 do not limit the scope of this disclosure to any particular implementation of a pipeline.

As shown in FIG. 6, thrust anchor key 622 protrudes from an exterior surface of the thrust anchor 614. The exterior surface of the thrust anchor 614 is a surface that is contacts interior surfaces of a ballast weight. The thrust anchor key 622 can extend a partial circumference of a cross section of the thrust anchor 614. The cross section of the pipe for the thrust anchor key 622 is defined based on a cross section perpendicular to a central axis of the thrust anchor 614. The thrust anchor key 622 can extend in a range from a fraction of an inch to a fraction of an inch less than a thickness of a locking ballast weight.

The thrust anchor key 622 can be fixed by any means to the thrust anchor 614, including prefabricating the thrust anchor key 622 on a thrust anchor 214. The thrust anchor 214 can be sized similarly to the thrust anchor 614 in the pipeline. That is, the thrust anchor 214 can have a same inner diameter, outer diameter, thickness, etc. to a pipe. The thrust anchor 214 can also be made of PE pipe. Use of the thrust anchor key 622 can function similarly to either of the thrust anchor rings 212, 412, 512. The thrust anchor key 622 can operate within the thrust anchor keyways 210, 310, 410, and 510. The thrust anchor key 622 can rotate freely within the thrust anchor keyways 210, 310, 410 but limit lateral movement of a ballast weight along a pipeline.

As shown in FIG. 7, thrust anchor keys 722 protrude from an exterior surface of the thrust anchor 714. The exterior surface of the thrust anchor 714 is a surface that is contacts interior surfaces of a ballast weight. The thrust anchor keys 722 can each extend a partial circumference of a cross section of the thrust anchor 714. The cross section of the pipe for the thrust anchor keys 722 is defined based on a cross section perpendicular to a central axis of the thrust anchor 714. The thrust anchor keys 722 can extend in a range from a fraction of an inch to a fraction of an inch less than a thickness of a locking ballast weight.

The thrust anchor keys 722 can be fixed by any means to the thrust anchor 714, including prefabricating the thrust anchor keys 722 on a thrust anchor 214. The thrust anchor 214 can be sized similarly to the thrust anchor 714 in the pipeline. That is, the thrust anchor 214 can have a same inner diameter, outer diameter, thickness, etc. to a pipe. The thrust anchor 214 can also be made of PE pipe. Use of the thrust anchor keys 722 can function similarly to either of the thrust anchor rings 212, 412, 512. The thrust anchor keys 722 can operate within the thrust anchor keyways 210, 310, 410, and 510. The thrust anchor keys 722 can rotate freely within the thrust anchor keyways 210, 310, 410 but limit lateral movement of a ballast weight along a pipeline.

Although FIGS. 6 and 7 illustrate example thrust anchor keys 622, 722, various changes may be made to FIGS. 6 and 7. For example, the number and placement of various components of the thrust anchor keys 622, 722 can vary as needed or desired. In addition, the thrust anchor keys 622, 722 may be used in any other suitable piping process and is not limited to the specific processes described above.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A pipeline comprising:
a pipe including an anchor ring extending from an exterior surface of the pipe; and
a ballast weight coupled around the pipe, the ballast weight including an anchor keyway designed as a channel into an interior surface of the ballast weight, wherein the anchor ring extends into the anchor keyway.

2. The pipeline of claim 1, wherein the ballast weight is a bullet ballast weight.

3. The pipeline of claim 1, wherein the ballast weight is a foundation ballast weight.

4. The pipeline of claim 1, wherein the anchor ring has a rectangular cross section extending from the pipe in a plane perpendicular to a center axis of the pipe.

5. The pipeline of claim 1, wherein the anchor ring has a triangular cross section in a plane perpendicular to a center axis of the pipe.

6. The pipeline of claim 1, wherein the anchor ring has a circular cross section in a plane perpendicular to a center axis of the pipe.

7. The pipeline of claim 1, wherein the anchor ring extends around an entire circumference of the pipe.

8. The pipeline of claim 1, wherein the anchor ring is an anchor key that partially extends around a circumference of the pipe.

9. A ballast weight assembly comprising:
a thrust anchor configured to couple to a pipe, the thrust anchor including an anchor ring protruding from an exterior surface of the pipe; and
a ballast weight coupled around the thrust anchor, the ballast weight including an anchor keyway designed as a channel into an interior surface of the ballast weight, wherein the anchor ring extends into the anchor keyway.

10. The ballast weight assembly of claim 9, wherein the ballast weight is a bullet ballast weight.

11. The ballast weight assembly of claim 9, wherein the ballast weight is a foundation ballast weight.

12. The ballast weight assembly of claim 9, wherein the anchor ring has a rectangular cross section extending from the thrust anchor in a plane perpendicular to a center axis of the thrust anchor.

13. The ballast weight assembly of claim 9, wherein the anchor ring has a triangular cross section in a plane perpendicular to a center axis of the thrust anchor.

14. The ballast weight assembly of claim 9, wherein the anchor ring has a circular cross section in a plane perpendicular to a center axis of the thrust anchor.

15. The ballast weight assembly of claim 9, wherein the anchor ring extends around an entire circumference of the thrust anchor.

16. The ballast weight assembly of claim 9, wherein the anchor ring is an anchor key that partially extends around a circumference of the thrust anchor.

17. The ballast weight assembly of claim 9, wherein the thrust anchor is sized to the thrust anchor.

18. A ballast weight configured to couple around a pipe, the ballast weight including:
an anchor keyway designed as a channel in an interior surface of the ballast weight,
wherein the anchor keyway is configured to receive an anchor ring extending from a thrust anchor or the pipe.

19. The ballast weight of claim 18, wherein the ballast weight is a bullet ballast weight.

20. The ballast weight of claim 18, wherein the ballast weight is a foundation ballast weight.
